(19) United States
(12) Patent Application Publication
(10) Pub. No.: US 2024/0253663 A1
(43) Pub. Date: Aug. 1, 2024

(54) GENERATING WORST-CASE CONSTRAINTS FOR AUTONOMOUS VEHICLE MOTION PLANNING

(71) Applicant: Motional AD LLC, Boston, MA (US)

(72) Inventors: Nathan Spielberg, Boston, MA (US); Alexander Brown, Dover, NH (US); Kevin C. Gall, Newmarket, NH (US); Georgios Mamakoukas, Boston, MA (US); Jesse Adam Miller, Cambridge, MA (US); Boaz Cornelis Floor, Cambridge, MA (US); Thomas Koelbaek Jespersen, Copenhagen (DK)

(21) Appl. No.: 18/120,325

(22) Filed: Mar. 10, 2023

(30) Foreign Application Priority Data
Jan. 27, 2023 (GR) 20230100065

(51) Int. Cl. B60W 60/00; B60W 30/09

(52) U.S. Cl. CPC B60W 60/0015; B60W 30/09

(57) ABSTRACT

Disclosed is an improved motion planner that safely and proactively considers worst-case agent behavior by generating a worst-case homotopy for every nominal homotopy. In some embodiments, a method comprises: generating a first set of maneuvers to be performed by a vehicle in a scenario, the first set of maneuvers based on an expected behavior of at least one agent proximate to the vehicle; generating a second set of maneuvers to be performed by the vehicle, the second set of maneuvers based on worst case behavior of the at least one agent proximate to the vehicle; generating a set of candidate trajectories based on the first set of maneuvers and the second set of maneuvers; selecting a trajectory from the set of candidate trajectories; and generating, with the at least one processor, at least one control signal to operate the vehicle based on the selected trajectory.

### CROSS-REFERENCE TO RELATED APPLICATION

This application claims priority to Greece Patent Application No. 20230100065, entitled “Generating Worst-Case Constraints for Autonomous Vehicle Motional Planning,” filed Jan. 27, 2023, the entire contents of which are incorporated herein by reference.

### BACKGROUND

Existing motion planners for autonomous vehicles only consider the nominal behaviors (expected cases) of agents surrounding the vehicle. Accordingly, existing motion planners plan in a reactive way to worst-case agent motion, which can lead to reactive and even dangerous vehicle motion, which in turn can lead to collisions and non-cautious behavior of the vehicle.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4A is a diagram of certain components of an autonomous system;

FIG. 4B is a diagram of an implementation of a neural network;

FIGS. 4C and 4D are a diagram illustrating example operation of a CNN;

FIG. 5 is a block diagram of a motion planner for an AV;

FIG. 6 is a block diagram of a worst-case homotopy extractor;

FIGS. 7A and 7B illustrate actor selection for two different example worst-case scenarios;

FIGS. 8A and 8B illustrate map-related generated worst-case constraints;

FIGS. 9A and 9B illustrate behaviors from generated worst-case constraints;

FIG. 9C illustrates that when the occlusion is cleared the vehicle behaves normally and proceeds on its way;

FIG. 9D shows a station time graph showing the maneuver including the nominal solution, worst-case solution and the station constraint for a vehicle, for the case when the occlusion has cleared;

FIGS. 10A and 10B illustrate semantics-related worst-case scenarios;

FIG. 10C illustrates a scenario where a pedestrian is not present between two parked vehicles;

FIG. 10D illustrates a scenario where a pedestrian is present between two parked vehicles;

FIGS. 10E and 10F are a station-time graph showing contingency longitudinal bounds and a graph of lateral error versus time for contingency lateral bounds, respectively, when the occlusion is present;

FIGS. 10G and 10H are a station-time graph showing contingency longitudinal bounds and a graph of lateral error versus time for contingency lateral bounds, respectively, when the occlusion is no longer present;

FIGS. 11A and 11B illustrate an additional semantics related worst-case scenario, according to one or more embodiments;

FIG. 11C illustrates the case where a pedestrian actually crosses crosswalk;

FIG. 11D illustrates the corresponding station-time graph for the scenario shown in FIG. 11C;

FIG. 11E illustrates the case where the pedestrian does not cross;

FIG. 11F illustrates the corresponding station-time graph for the scenario shown in FIG. 11E;

FIG. 12 is a station-time graph that illustrates most-constraining assumed worst-case scenarios;

FIG. 13 is a block diagram of motion planner for an AV that uses nominal and contingency MPC, according to some embodiments;

FIG. 14 is a station-time graph that illustrates the benefits of motion planner for the example of an agent in a lead position in front of vehicle and suddenly stopping; and

FIG. 15 is a flow diagram of a process for motion planning that considers worst-case scenarios for trajectory realization.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

Existing motion planners consume nominal predictions which are used to generate nominal homotopies (corridors that the AV can drive in). The disclosed improved motion planner safely and proactively considers worst-case agent behavior by generating a worst-case homotopy for every nominal homotopy. The disclosed improved motion planner takes into account sensor information when generating worst-case constraints to allow the motion planner to anticipate worst-case events rather than react when a given worst-case event occurs. The improved motion planner takes into account map information, perception information, and nominal homotopy decisions to generate worst-case constraints. Prioritized and selected worst-case agents are used to generate the worst-case constraints according to rule-based extreme actor behavior. A union of the generated worst-cases is used to generate a worst-case homotopy that is represented by a set of constraints.

In some embodiments, a method comprises: generating, with at least one processor, a first set of maneuvers to be performed by a vehicle in a scenario, the first set of maneuvers based on an expected behavior of at least one agent proximate to the vehicle; generating, with the at least one processor, a second set of maneuvers to be performed by the vehicle, the second set of maneuvers based on worst case behavior of the at least one agent proximate to the vehicle; generating, with the at least one processor, a set of candidate trajectories based on the first set of maneuvers and the second set of maneuvers; selecting, with the at least one processor, a trajectory from the set of candidate trajectories; and generating, with the at least one processor, at least one control signal to operate the vehicle based on the selected trajectory.

In some embodiments, the method further comprises: adding, based on at least one of map information or perception information, at least one observed agent, or at least one hallucinated agent in an occluded part of a map of the operating environment of the vehicle; and obtaining the second set of maneuvers from a set of predetermined worst-cases based on a specified scenario based on the at least one agent proximate to the vehicle and the at least one hallucinated agent.

In some embodiments, the predetermined worst-cases are associated with a location of the vehicle relative to the map.

In some embodiments, the predetermined worst-cases are semantics related to the at least one agent.

In some embodiments, obtaining the predetermined worst-cases comprises obtaining predetermined worst cases that are assumed worst-cases from specified agents.

In some embodiments, the method further comprises combining the second set of candidate maneuvers in a union to extract a most constrained second maneuver.

In some embodiments, generating the second set of candidate trajectories comprises generating the second set of candidate trajectories based on a reachable state prediction of how far and where the at least one hallucinated agent will travel in a specified amount of time.

In some embodiments, the method further comprises generating the second set of candidate trajectories based on velocity or acceleration profiles of the at least one hallucinated agent.

In some embodiments, the method further comprises generating the second set of candidate trajectories based on lane graph parameters.

In some embodiments, there are two or more hallucinated agents added to the occluded part of the map, and the method further comprises: selecting at least one most constraining hallucinated agent; and generating the second set of trajectories for the selected at least one most constraining hallucinated agent.

In some embodiments, generating at least one control signal comprises: inputting constraint sets for the nominal and contingency maneuvers into a model-based predictive control (MPC); and generating the at least one control signal based on a solution output by the MPC.

In some embodiments, the method further comprises generating the at least one control signal based on an optimization of at least one cost function and the constraint sets.

By virtue of the embodiments described herein, the disclosed systems and methods provide at least the following advantages: 1) explicitly considers safety under an assumed worst-case event; 2) allows an autonomous vehicle to anticipate the possibility that a worst-case event may occur, and not just react to the worst-case event; 3) allows a controls designer to decouple performance in the nominal and worst case scenario; 4) leads to behavior more similar to human drivers; 5) improves safety by adding prediction robustness in the planning and control stack; and 6) helps explain the maneuvers of an autonomous vehicle by focusing on scenarios that can be attributed to specific agents.

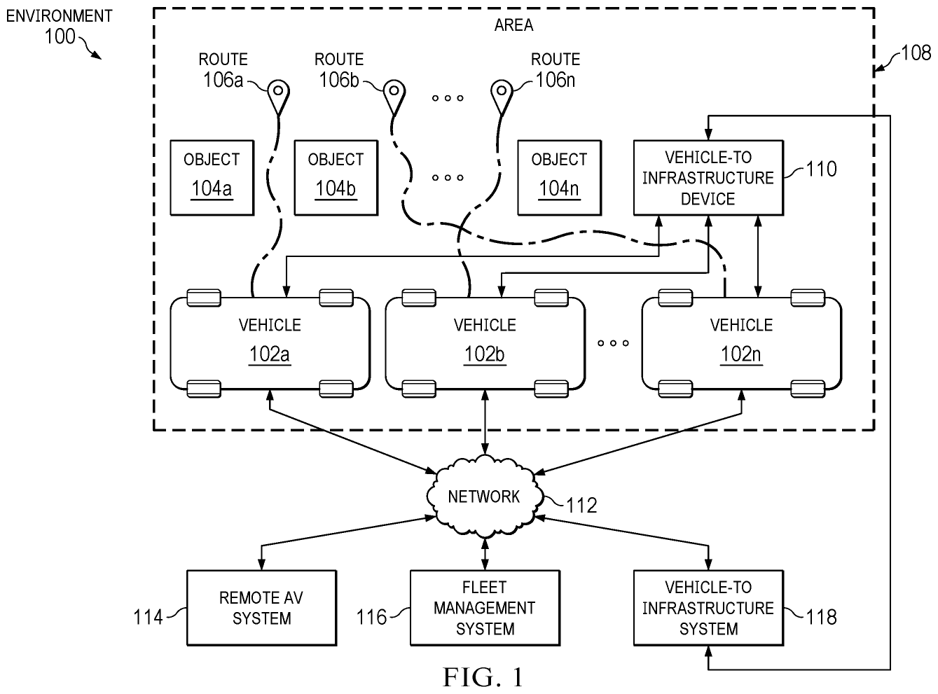

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

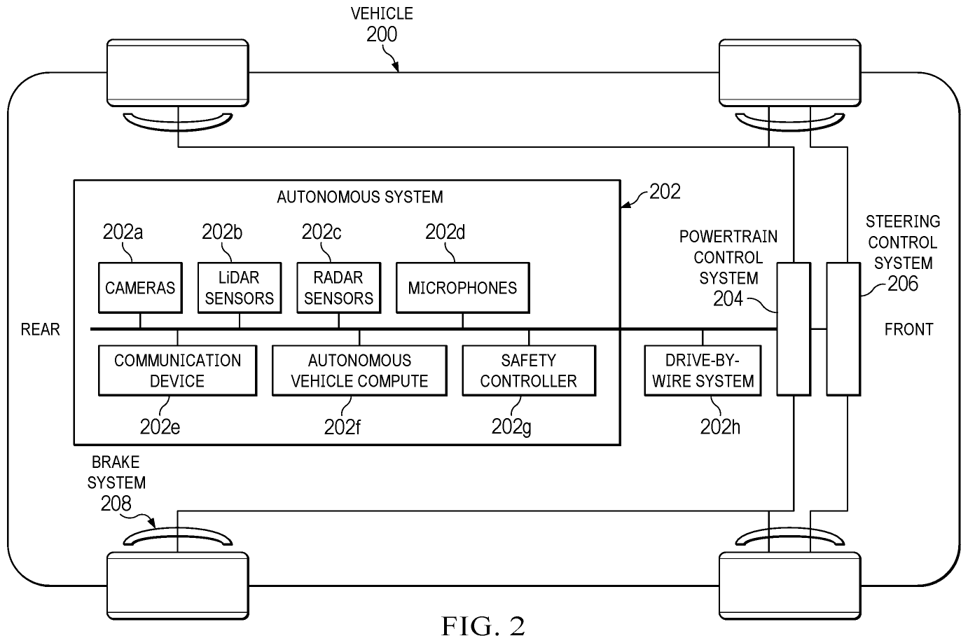

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicles 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In one embodiment, autonomous system 202 includes operational or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

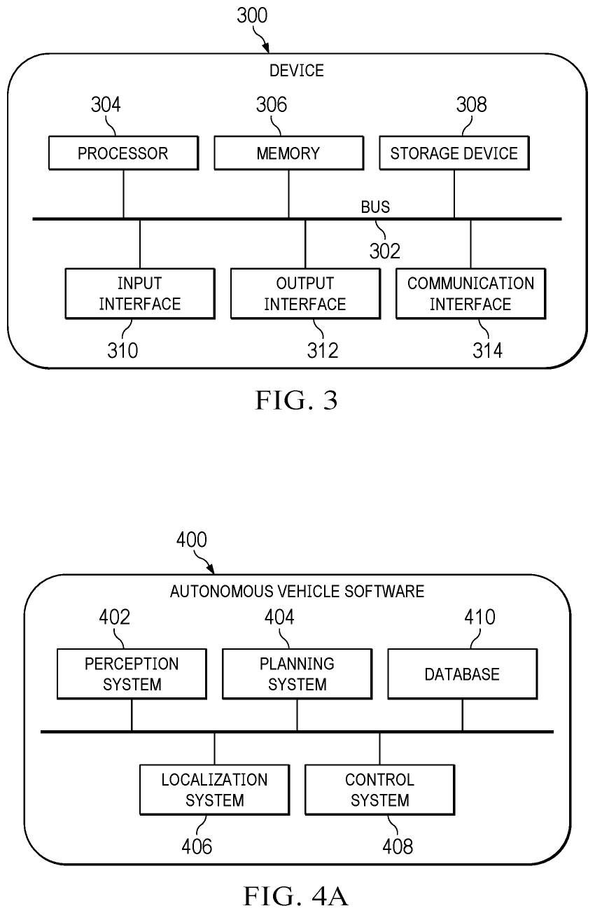

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charge-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is configured to implement autonomous vehicle software 400, described herein. In an embodiment, autonomous vehicle compute 202 f is the same or similar to distributed computing architecture 500, described here. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to make longitudinal vehicle motion, such as start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right. In other words, steering control system 206 causes activities necessary for the regulation of the y-axis component of vehicle motion.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102) and/or one or more devices of network 112 (e.g., one or more devices of a system of network 112). In some embodiments, one or more devices of vehicles 102 (e.g., one or more devices of a system of vehicles 102) and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), a neural processing unit (NPU) and/or the like), a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, dynamic RAM (DRAM), and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

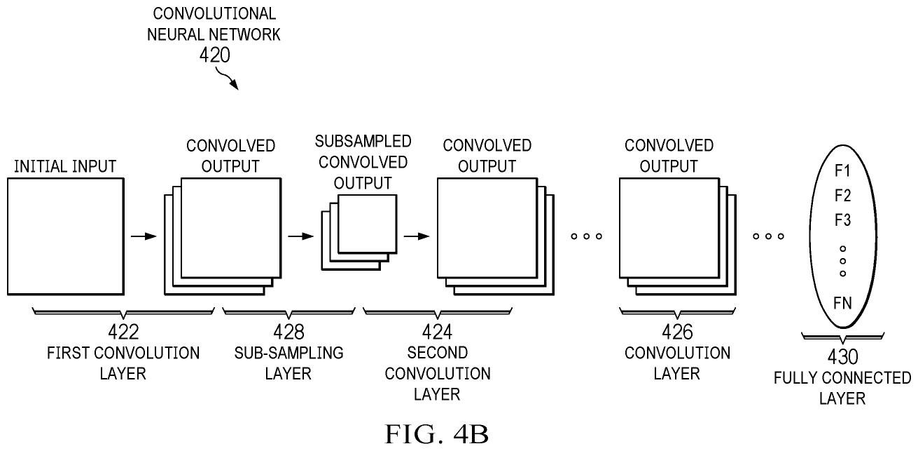

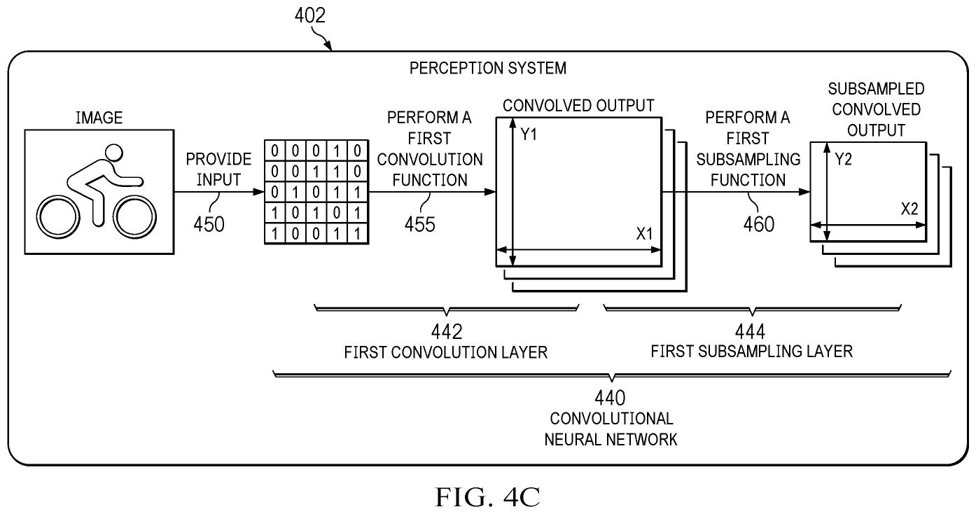

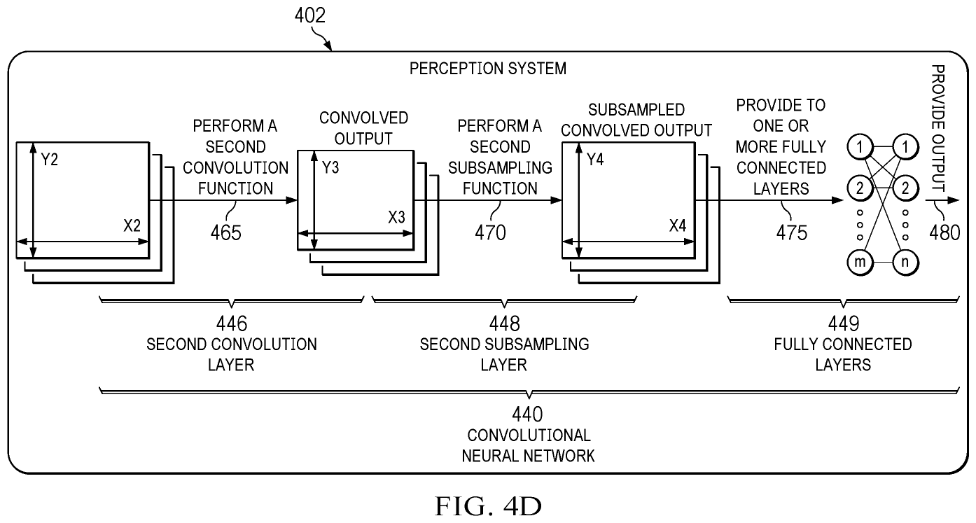

Referring now to FIG. 4, illustrated is an example block diagram of an autonomous vehicle software 400 (sometimes referred to as an “AV stack”). As illustrated, autonomous vehicle software 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle software 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle software 400 are implemented in software (e.g., in software instructions stored in memory) by computer hardware (e.g., by microprocessors, microcontrollers, application-specific integrated circuits (ASICs), Field Programmable Gate Arrays (FPGAs), and/or the like), chiplets, or distributed computing architectures. It will also be understood that, in some embodiments, autonomous vehicle software 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deacceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like). An example of an implementation of a machine learning model is included below with respect to FIGS. 4B-4D.

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle software 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LIDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

Referring now to FIG. 4B, illustrated is a diagram of an implementation of a machine learning model. More specifically, illustrated is a diagram of an implementation of a convolutional neural network (CNN) 420. For purposes of illustration, the following description of CNN 420 will be with respect to an implementation of CNN 420 by perception system 402. However, it will be understood that in some examples CNN 420 (e.g., one or more components of CNN 420) is implemented by other systems different from, or in addition to, perception system 402 such as planning system 404, localization system 406, and/or control system 408. While CNN 420 includes certain features as described herein, these features are provided for the purpose of illustration and are not intended to limit the present disclosure.

CNN 420 includes a plurality of convolution layers including first convolution layer 422, second convolution layer 424, and convolution layer 426. In some embodiments, CNN 420 includes sub-sampling layer 428 (sometimes referred to as a pooling layer). In some embodiments, sub-sampling layer 428 and/or other subsampling layers have a dimension (i.e., an amount of nodes) that is less than a dimension of an upstream system. By virtue of sub-sampling layer 428 having a dimension that is less than a dimension of an upstream layer, CNN 420 consolidates the amount of data associated with the initial input and/or the output of an upstream layer to thereby decrease the amount of computations necessary for CNN 420 to perform downstream convolution operations. Additionally, or alternatively, by virtue of sub-sampling layer 428 being associated with (e.g., configured to perform) at least one subsampling function (as described below with respect to FIGS. 4C and 4D), CNN 420 consolidates the amount of data associated with the initial input.

Perception system 402 performs convolution operations based on perception system 402 providing respective inputs and/or outputs associated with each of first convolution layer 422, second convolution layer 424, and convolution layer 426 to generate respective outputs. In some examples, perception system 402 implements CNN 420 based on perception system 402 providing data as input to first convolution layer 422, second convolution layer 424, and convolution layer 426. In such an example, perception system 402 provides the data as input to first convolution layer 422, second convolution layer 424, and convolution layer 426 based on perception system 402 receiving data from one or more different systems (e.g., one or more systems of a vehicle that is the same as or similar to vehicle 102), a remote AV system that is the same as or similar to remote AV system 114, a fleet management system that is the same as or similar to fleet management system 116, a V2I system that is the same as or similar to V2I system 118, and/or the like). A detailed description of convolution operations is included below with respect to FIG. 4C.

In some embodiments, perception system 402 provides data associated with an input (referred to as an initial input) to first convolution layer 422 and perception system 402 generates data associated with an output using first convolution layer 422. In some embodiments, perception system 402 provides an output generated by a convolution layer as input to a different convolution layer. For example, perception system 402 provides the output of first convolution layer 422 as input to sub-sampling layer 428, second convolution layer 424, and/or convolution layer 426. In such an example, first convolution layer 422 is referred to as an upstream layer and sub-sampling layer 428, second convolution layer 424, and/or convolution layer 426 are referred to as downstream layers. Similarly, in some embodiments perception system 402 provides the output of sub-sampling layer 428 to second convolution layer 424 and/or convolution layer 426 and, in this example, sub-sampling layer 428 would be referred to as an upstream layer and second convolution layer 424 and/or convolution layer 426 would be referred to as downstream layers.

In some embodiments, perception system 402 processes the data associated with the input provided to CNN 420 before perception system 402 provides the input to CNN 420. For example, perception system 402 processes the data associated with the input provided to CNN 420 based on perception system 402 normalizing sensor data (e.g., image data, LiDAR data, radar data, and/or the like).

In some embodiments, CNN 420 generates an output based on perception system 402 performing convolution operations associated with each convolution layer. In some examples, CNN 420 generates an output based on perception system 402 performing convolution operations associated with each convolution layer and an initial input. In some embodiments, perception system 402 generates the output and provides the output as fully connected layer 430. In some examples, perception system 402 provides the output of convolution layer 426 as fully connected layer 430, where fully connected layer 430 includes data associated with a plurality of feature values referred to as F1, F2 . . . FN. In this example, the output of convolution layer 426 includes data associated with a plurality of output feature values that represent a prediction.

In some embodiments, perception system 402 identifies a prediction from among a plurality of predictions based on perception system 402 identifying a feature value that is associated with the highest likelihood of being the correct prediction from among the plurality of predictions. For example, where fully connected layer 430 includes feature values F1, F2, . . . FN, and F1 is the greatest feature value, perception system 402 identifies the prediction associated with F1 as being the correct prediction from among the plurality of predictions. In some embodiments, perception system 402 trains CNN 420 to generate the prediction. In some examples, perception system 402 trains CNN 420 to generate the prediction based on perception system 402 providing training data associated with the prediction to CNN 420.

Referring now to FIGS. 4C and 4D, illustrated is a diagram of example operation of CNN 440 by perception system 402. In some embodiments, CNN 440 (e.g., one or more components of CNN 440) is the same as, or similar to, CNN 420 (e.g., one or more components of CNN 420) (see FIG. 4B).

At step 450, perception system 402 provides data associated with an image as input to CNN 440 (step 450). For example, as illustrated, perception system 402 provides the data associated with the image to CNN 440, where the image is a greyscale image represented as values stored in a two-dimensional (2D) array. In some embodiments, the data associated with the image may include data associated with a color image, the color image represented as values stored in a three-dimensional (3D) array. Additionally, or alternatively, the data associated with the image may include data associated with an infrared image, a radar image, and/or the like.

At step 455, CNN 440 performs a first convolution function. For example, CNN 440 performs the first convolution function based on CNN 440 providing the values representing the image as input to one or more neurons (not explicitly illustrated) included in first convolution layer 442. In this example, the values representing the image can correspond to values representing a region of the image (sometimes referred to as a receptive field). In some embodiments, each neuron is associated with a filter (not explicitly illustrated). A filter (sometimes referred to as a kernel) is representable as an array of values that corresponds in size to the values provided as input to the neuron. In one example, a filter may be configured to identify edges (e.g., horizontal lines, vertical lines, straight lines, and/or the like). In successive convolution layers, the filters associated with neurons may be configured to identify successively more complex patterns (e.g., arcs, objects, and/or the like).

In some embodiments, CNN 440 performs the first convolution function based on CNN 440 multiplying the values provided as input to each of the one or more neurons included in first convolution layer 442 with the values of the filter that corresponds to each of the one or more neurons. For example, CNN 440 can multiply the values provided as input to each of the one or more neurons included in first convolution layer 442 with the values of the filter that corresponds to each of the one or more neurons to generate a single value or an array of values as an output. In some embodiments, the collective output of the neurons of first convolution layer 442 is referred to as a convolved output. In some embodiments, where each neuron has the same filter, the convolved output is referred to as a feature map.

In some embodiments, CNN 440 provides the outputs of each neuron of first convolutional layer 442 to neurons of a downstream layer. For purposes of clarity, an upstream layer can be a layer that transmits data to a different layer (referred to as a downstream layer). For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of first subsampling layer 444. In some embodiments, CNN 440 adds a bias value to the aggregates of all the values provided to each neuron of the downstream layer. For example, CNN 440 adds a bias value to the aggregates of all the values provided to each neuron of first subsampling layer 444. In such an example, CNN 440 determines a final value to provide to each neuron of first subsampling layer 444 based on the aggregates of all the values provided to each neuron and an activation function associated with each neuron of first subsampling layer 444.

At step 460, CNN 440 performs a first subsampling function. For example, CNN 440 can perform a first subsampling function based on CNN 440 providing the values output by first convolution layer 442 to corresponding neurons of first subsampling layer 444. In some embodiments, CNN 440 performs the first subsampling function based on an aggregation function. In an example, CNN 440 performs the first subsampling function based on CNN 440 determining the maximum input among the values provided to a given neuron (referred to as a max pooling function). In another example, CNN 440 performs the first subsampling function based on CNN 440 determining the average input among the values provided to a given neuron (referred to as an average pooling function). In some embodiments, CNN 440 generates an output based on CNN 440 providing the values to each neuron of first subsampling layer 444, the output sometimes referred to as a subsampled convolved output.

At step 465, CNN 440 performs a second convolution function. In some embodiments, CNN 440 performs the second convolution function in a manner similar to how CNN 440 performed the first convolution function, described above. In some embodiments, CNN 440 performs the second convolution function based on CNN 440 providing the values output by first subsampling layer 444 as input to one or more neurons (not explicitly illustrated) included in second convolution layer 446. In some embodiments, each neuron of second convolution layer 446 is associated with a filter, as described above. The filter(s) associated with second convolution layer 446 may be configured to identify more complex patterns than the filter associated with first convolution layer 442, as described above.

In some embodiments, CNN 440 performs the second convolution function based on CNN 440 multiplying the values provided as input to each of the one or more neurons included in second convolution layer 446 with the values of the filter that corresponds to each of the one or more neurons. For example, CNN 440 can multiply the values provided as input to each of the one or more neurons included in second convolution layer 446 with the values of the filter that corresponds to each of the one or more neurons to generate a single value or an array of values as an output.

In some embodiments, CNN 440 provides the outputs of each neuron of second convolutional layer 446 to neurons of a downstream layer. For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of second subsampling layer 448. In some embodiments, CNN 440 adds a bias value to the aggregates of all the values provided to each neuron of the downstream layer. For example, CNN 440 adds a bias value to the aggregates of all the values provided to each neuron of second subsampling layer 448. In such an example, CNN 440 determines a final value to provide to each neuron of second subsampling layer 448 based on the aggregates of all the values provided to each neuron and an activation function associated with each neuron of second subsampling layer 448.

At step 470, CNN 440 performs a second subsampling function. For example, CNN 440 can perform a second subsampling function based on CNN 440 providing the values output by second convolution layer 446 to corresponding neurons of second subsampling layer 448. In some embodiments, CNN 440 performs the second subsampling function based on CNN 440 using an aggregation function. In an example, CNN 440 performs the first subsampling function based on CNN 440 determining the maximum input or an average input among the values provided to a given neuron, as described above. In some embodiments, CNN 440 generates an output based on CNN 440 providing the values to each neuron of second subsampling layer 448.

At step 475, CNN 440 provides the output of each neuron of second subsampling layer 448 to fully connected layers 449. For example, CNN 440 provides the output of each neuron of second subsampling layer 448 to fully connected layers 449 to cause fully connected layers 449 to generate an output. In some embodiments, fully connected layers 449 are configured to generate an output associated with a prediction (sometimes referred to as a classification). The prediction may include an indication that an object included in the image provided as input to CNN 440 includes an object, a set of objects, and/or the like. In some embodiments, perception system 402 performs one or more operations and/or provides the data associated with the prediction to a different system, described herein.

### Example Motion Planner

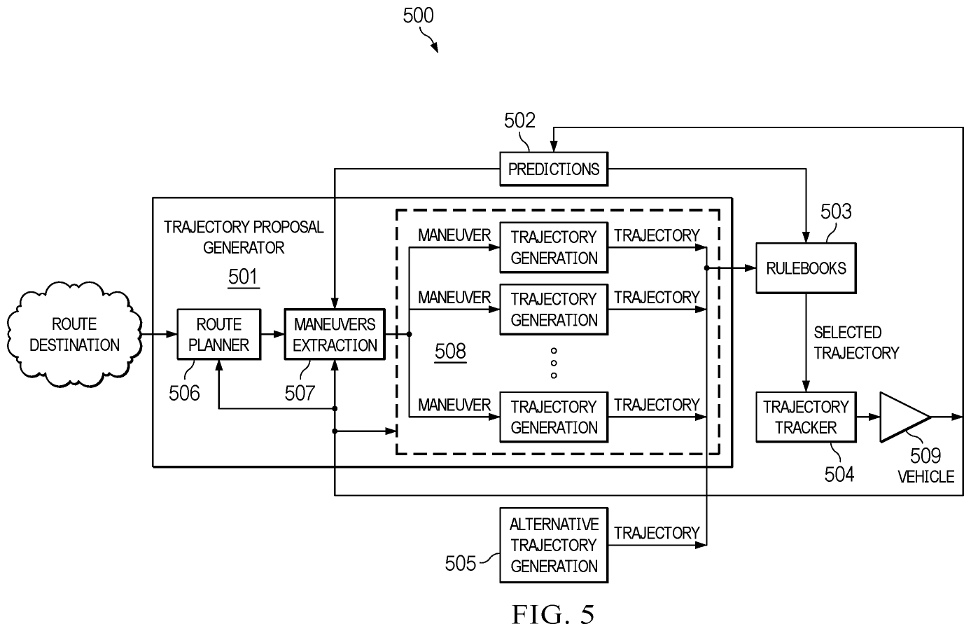

FIG. 5 is a block diagram of motion planner 500 for an AV, according one or more embodiments. For purposes of illustration, the following description of motion planner 500 will be with respect to an implementation of motion planner 500 by planner system 404. However, it will be understood that in some examples motion planner 500 (e.g., one or more components of motion planner 500) is implemented by other systems different from, or in addition to, planning system 404 such as perception system 402, localization system 406, and/or control system 408. While motion planner 500 includes certain features as described herein, these features are provided for the purpose of illustration and are not intended to limit the present disclosure.

In some embodiments, motion planner 500 includes trajectory proposal generator 501, state predictor 502, trajectory selector (rulebooks) 503, trajectory tracker 504 and alternative trajectory generator 505. Trajectory proposal generator 501 further includes route planner 506, maneuver (homotopy) extractor 507 and candidate trajectory generator 508.

Motion planner 500 is a “propose and select” mechanism that extracts multiple nominal homotopies (maneuvers) along the route by choosing active constraint sets, finding a candidate trajectory (realization) within each resulting homotopy, cost scoring valid trajectories (trajectories that do not violate the constraint sets) based on rulebooks, selecting the best trajectory of the candidate trajectories based on the scores, and sending the constraint set for the best trajectory to vehicle tracker 504 for generating control signals for controlling vehicle 509 so that vehicle 509 follows the selected best trajectory.

In operation, route and destination information is input into route planner 506 which generates a route to the destination. The route is input into maneuver extractor 507 which outputs a number of homotopies based on the predicted states (e.g., position, velocity, acceleration, heading) of agents by state predictor 502 and the state of vehicle 509. Candidate trajectory generator 508 generates a trajectory for each homotopy (maneuver) which is compared with rules in trajectory selector 503 in an iterative optimization problem that scores each candidate trajectory based on a minimization of one or more cost functions (e.g., collision, comfort). In some embodiments, a best trajectory is selected based on comparison of the scores, where in some embodiments the candidate trajectory with the lowest cost score is selected as the best trajectory for the vehicle.

The constraint set for the selected trajectory is input to trajectory tracker 504, which implements a control model, such as model-predictive control (MPC) model that solves an optimization problem at each time step to find an optimal control action (e.g., acceleration, deceleration, braking, steering angle) that drives vehicle 509 as close as possible to the selected best trajectory. In some embodiments, alternative trajectory generator 505 generates an alternative trajectory independent of the trajectory proposal generator 501 for backup operations.

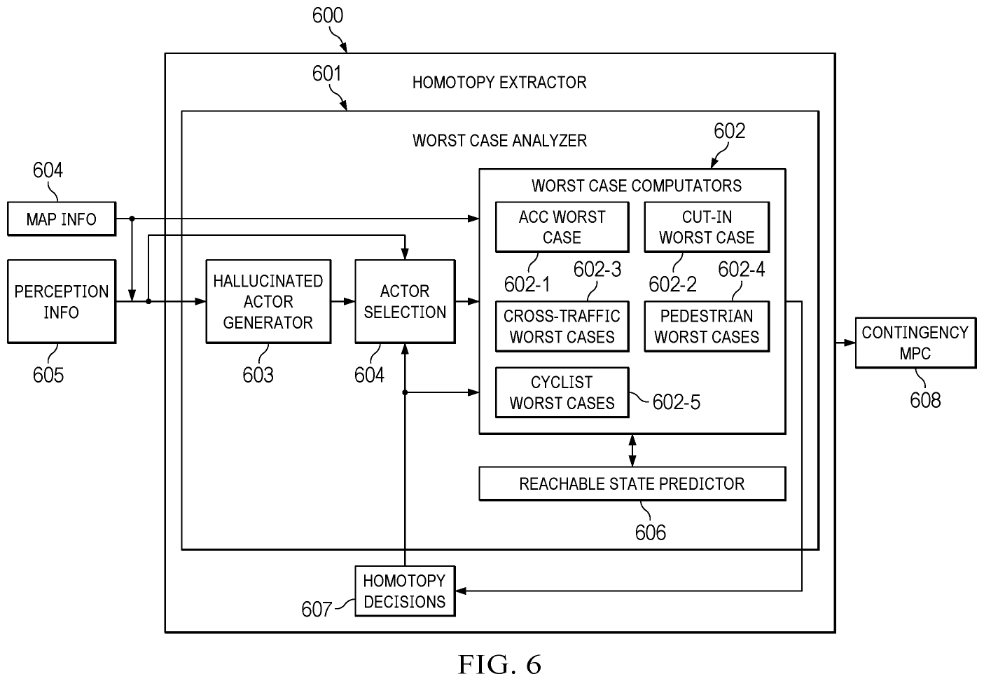

Motion planner 500 consumes nominal predictions 507 which are used in generating nominal homotopies (corridors that vehicle 509 can drive in). To have motion planner 500 safely and proactively consider worst-case agent behavior, an improved motion planner 500 also generates a worst-case homotopy for every nominal homotopy. For motion planner 500 to consume worst-case homotopies, the worst-case homotopies are generated taking into account map information, perception information and nominal homotopy decisions, as described more fully in reference to FIG. 6.

### Example Worst-Case Homotopy Extractor

FIG. 6 is a block diagram of a worst-case homotopy extractor 600, according to one or more embodiments. For purposes of illustration, the following description of worst-case homotopy extractor 600 will be with respect to an implementation of motion planner 500 by planner system 404. However, it will be understood that in some examples worst-case homotopy extractor 600 (e.g., one or more components of worst-case homotopy extractor 600) is implemented by other systems different from, or in addition to, planning system 404 such as perception system 402, localization system 406, and/or control system 408. While worst-case homotopy extractor 600 includes certain features as described herein, these features are provided for the purpose of illustration and are not intended to limit the present disclosure.

Worst-case homotopy extractor 600 includes worst-case analyzer 601 and worst-case computators 602. Worst-case analyzer 601 includes hallucinated actor generator 603 and actor selector 604. Worst-case computators 602 include five example worst-case computators, including ACC worst cases 602-1, cut-in worst cases 602-2, cross-traffic worst cases 602-3, pedestrian worst cases 602-4 and cyclist worst cases 602-5.

Worst-case analyzer 601 takes map information 604 and perception information 605 (e.g., object detections) as input. From these input, various worst-case scenarios are generated, including map-related worst-cases (e.g., parking zones and known occluded regions), semantics-related worst-case scenarios (e.g., agent-map interactions, such as agents hiding behind parked vehicles) and assumed worst-case scenarios from existing agents.

Hallucinated actor generator 603 uses semantics-related worst-case scenarios and occlusion information from map information 604 to determine whether to hallucinate agents in occluded parts of the map. From the agents in the scene and the hallucinated agents, worst-case computators 602 generate a set of worst case trajectories depending on the worst-case scenario. These worst-case trajectories are dependent on reachable state predictor 606, which predicts which set of states are reachable for an agent given their current state (e.g., position, velocity, heading). Individual worst case predictions are combined in a union to extract the most constraining worst case homotopy. The most constraining worst-case homotopy is input into contingency MPC 608, which consumes both nominal constraints 607 and worst-case constraints and generates control signals for vehicle 509.

In some embodiments, the MPC 608 implements a cost function with nominal and worst-case constraints, which can be represented mathematically by Equation [1]:

$${min}_{x , u , λ , {x}_{c} , {u}_{c} , {λ}_{c}} {\sum }_{i = 1}^{N} ( ( 1 - {Q}_{c} ) {J}_{stage} ( {x}^{i} , {u}^{i} , {λ}^{i} ) + {Q}_{c} {J}_{{stage}_{c}} ( {x}_{c}^{i} , {u}_{c}^{i} , {λ}_{c}^{i} ) ) + ( 1 - {Q}_{c} ) {J}_{terminal} ( {x}^{N} ) + {Q}_{c} {J}_{terminal} ( {x}_{c}^{N} )$$

$${x}^{i + 1} = f ( {x}_{i} , {u}_{i} )$$

$${x}_{c}^{i + 1} = f ( {x}_{c}^{i} , {u}_{c}^{i} )$$

$${C}^{i} ( {x}^{i} , {u}^{i} , {λ}^{i} ) \leq 0$$

$${C}_{c}^{i} ( {x}_{c}^{i} , {u}_{c}^{i} , {λ}_{c}^{i} ) \leq 0$$

$$x ∈ X$$

$${x}_{c} ∈ {X}_{c}$$

$$u ∈ U$$

$${u}_{c} ∈ {U}_{c}$$

$$λ ∈ Λ$$

$${λ}_{c} ∈ {Λ}_{c}$$

$${x}^{i} = {x}_{c}^{i} ∀ i \leq {i}_{pin}$$

In Equation [1], cⁱ(xⁱ, uⁱ, λⁱ)≤0 are nominal constraints and C_{c}ⁱ(x_{c}ⁱ, u_{c}ⁱ, λ_{c}ⁱ)≤0 are worst-case constraints. Q_{c}[0, 1] weighs the probability of contingency and allows for a convex combination between nominal and contingent costs. When Q_{c} is 0, nominal performance is obtained without considering the contingency, and when Q_{c} is 1, the contingency is optimized only and the nominal homotopy is ignored.

In an embodiment, the optimization problem in Equation [1] can be formulated in state space defined in a curvilinear coordinate frame, where the states are defined with respect to a center of gravity (CoG) of the vehicle. Six slack variables are introduced as additional inputs to account for soft constraints. In this example embodiment, trajectory tracker 504 takes as input the selected trajectory output by trajectory selector 503 parameterized in time.

This means that trajectory tracker 504 can query the exact desired position of the AV, xᵢ=[s, n, μ, v, α, δ, \dot{δ}] at any time tᵢ, where s progress, n is lateral error, μ is local heading (difference between the vehicle heading in the map frame and the curvilinear reference heading), v is longitudinal velocity, a is longitudinal vehicle acceleration, δ is the steering angle, \dot{δ} is the steering rate, u is a vector of input variables including jerk and steering rate

$$u = [ \begin{matrix}{u}_{j e r k} \\ {u}_{\ddot{δ}}\end{matrix} ] , and λ = [ \begin{matrix}{λ}_{n} \\ {λ}_{v} \\ {λ}_{a}\end{matrix} ]$$

are slack variables, where λₙ is slack on the soft lateral tube, λᵥ is slack on soft velocity, λₐ is slack on soft acceleration, and J_{stage}( ) and Jₜₑᵣₘᵢₙₐₗ( ) are cost functions.

Equation [1] can be solved using any suitable solver. Other embodiments can use different trajectory optimization methods, including but not limited to learning-based methods or methods that use control barrier functions.

In an embodiment, the motion model is a kinematic bicycle model that allows the side slip angle β to be defined geometrically, so that the velocity v and yaw rate ψ of the vehicle can be expressed in terms of δ, as shown in Equations [2] and [3]:

$$\dot{x} = [ \begin{matrix}\dot{s} \\ \dot{n} \\ \dot{μ} \\ \dot{v} \\ \dot{a} \\ \dot{δ} \\ \ddot{δ}\end{matrix} ] = [ \begin{matrix}\frac{v cos ( μ + β )}{1 - n κ} \\ v sin ( μ + β ) \\ \frac{v}{{l}_{r}} sin ( β ) - κ \frac{v cos ( μ + β )}{l - n κ} \\ a \\ {u}_{j e r k} \\ \dot{δ} \\ {u}_{\ddot{δ}}\end{matrix} ] , \qquad [ 2 ]$$

$$where$$

$$β = arctan ( \frac{{l}_{r}}{{l}_{r} + {l}_{f}} {δ}_{r e a l} ) ) , and \qquad [ 3 ]$$

where lᵣ is the length from the front of the AV to the CoG of the vehicle and l_{f} is the length from the rear of the vehicle to the CoG of the vehicle.

In an embodiment, the cost functions J_{stage} and Jₜₑᵣₘᵢₙₐₗ are given by:

$${J}_{stage} = {J}_{comfort} ( {x}_{k} , {u}_{k} ) + {J}_{tracking} ( {x}_{k} ) + {J}_{slack} ( {s}_{k} ) ∀ k ∈ \{ 0 , … , N - 1 \} , \qquad [ 4 a ]$$

$${J}_{stage} = {J}_{comfort} ( {x}_{{c}_{k}} , {u}_{{c}_{k}} ) + {J}_{tracking} ( {x}_{{c}_{k}} ) + {J}_{slack} ( {s}_{{c}_{k}} ) ∀ k ∈ \{ 0 , … , N - 1 \} \qquad [ 4 b ]$$

$$and$$

$${J}_{terminal} = {J}_{tracking} ( {x}_{N} ) + {J}_{slack} ( {s}_{N} ) \qquad [ 5 a ]$$

$${J}_{terminal} = {J}_{tracking} ( {x}_{{c}_{N}} ) + {J}_{slack} ( {s}_{{c}_{N}} ) . \qquad [ 5 b ]$$

Equations [4a] and [5a] are the cost functions for the nominal case constraints and Equations [4b] and [5b] are the cost functions for the worst-case constraints. In an embodiment, tracking performance is only required for the first three states, the comfort requirement is applicable to acceleration and both inputs. In some embodiments, both the tracking and comfort objectives are implemented as a quadratic cost. In some embodiments, slack violation is penalized by either a quadratic or a linear cost.

Referring again to FIG. 6, worst-case computators 602 are used to compute a set of worst-case constraints that do not over-constrain the vehicle. If every worst-case is considered, the vehicle can never move forward. Instead, focus is on a discrete set of scenarios to handle. The set of scenarios provide bounds to reasonable worst cases and allow traceability of anticipatory behaviors in the vehicle stack. Worst-case computators 602 compute worst case trajectories given a specific scenario. Worst-case computators 602 also consume actors which selectively constrain the vehicle. For example, a lead vehicle that cannot be passed.

There can be any number of scenarios for which worst-case computators 602 can generate trajectories, including but not limited to: ACC (adaptive cruise control) worst-case scenarios 602-1, such as a lead vehicle hard-braking, cut-in worst case scenarios 602-2, such as aggressive cut-ins, cross-traffic worst case scenarios 602-3, such as agents acting outside of a precedence model, pedestrian worst case scenarios 602-4, such as jaywalkers walking into the middle of the road or exiting a parked vehicle and cyclist worst-case scenarios 602-5, such as driving direction violations or “bending” road rules. In some embodiments, worst-case computators 602 use reachable state predictor 606 to determine how far and where a given agent can possibly travel in a specified amount of time. Reachable state predictor 606 is a parameterized tool that: 1) determines the possible states of an actor after a given time; 2) utilizes map semantics and actor profiles to estimate worst cases that conform to supported scenarios; 3) includes parameters for velocity/acceleration profiles and lane graph/association; and 4) determines how far and where a given vehicle/actor will travel in a specified amount of time.

### Example Actor Selection

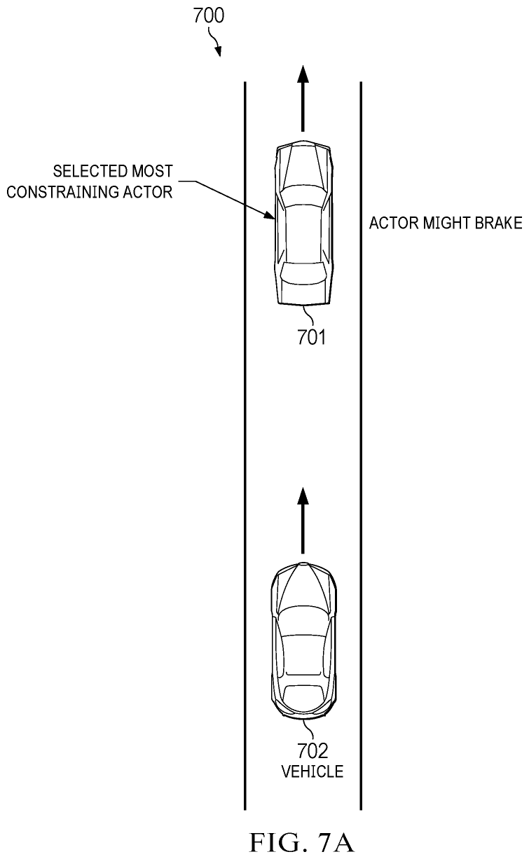

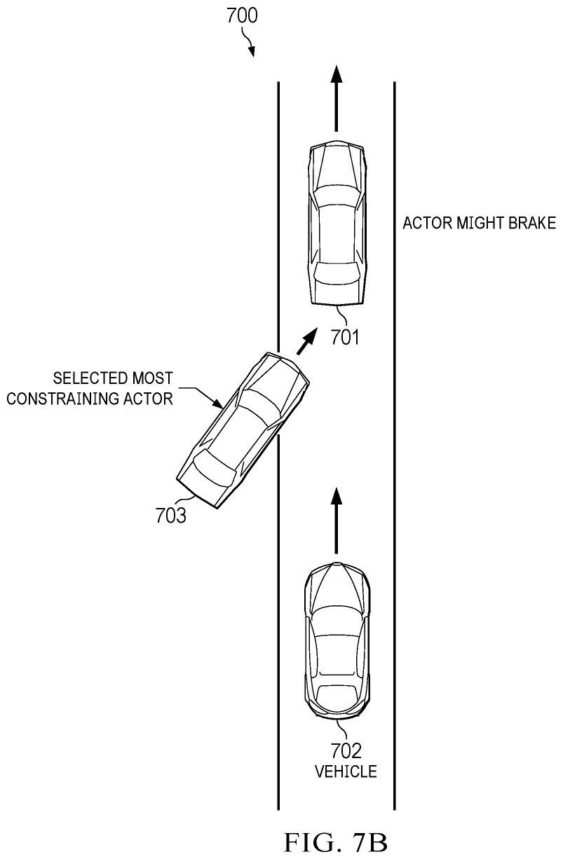

FIGS. 7A and 7B illustrate actor selection for two different example worst-case scenarios, according to one or more embodiments. For different worst-case scenarios, only a subset of agents (of those in a full scene) are included in the worst-case computation. For example, FIG. 7A illustrates an ACC longitudinal worst case scenario, where the selected most constraining agent 701 is a lead agent vehicle in front of vehicle 702 that might brake. In FIG. 7B, the selected most constraining agent 703 is the vehicle agent cutting into the lane of vehicle 702 even though agent 701 may brake. Note that other agents in the scenario may not be selected because their motion in the worst-case may not in fluence the safe behavior of vehicle.

### Example Map-Related Generated Worst-Case Scenarios

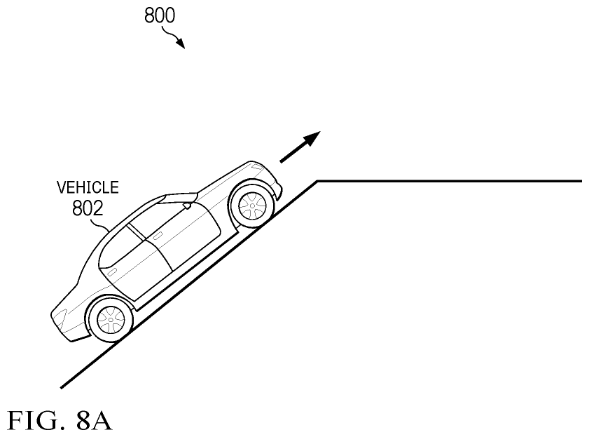

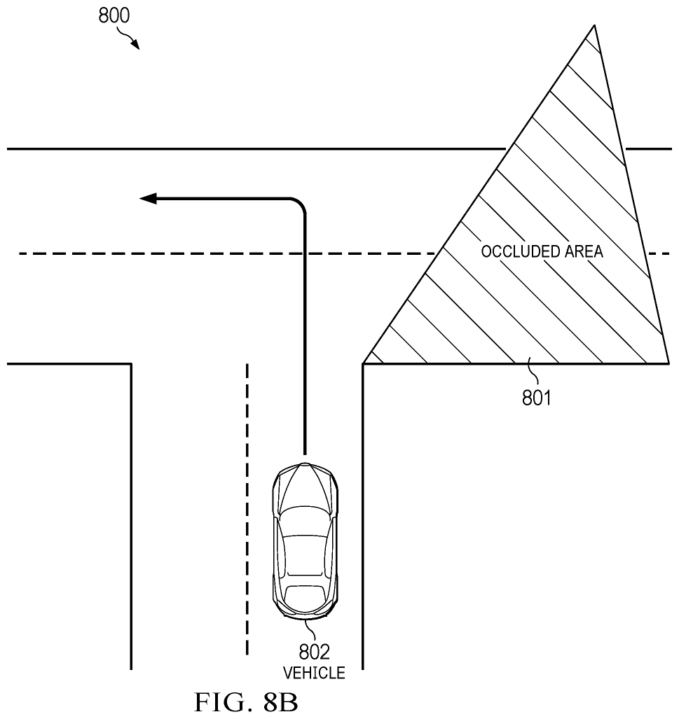

FIGS. 8A and 8B illustrate side and birds eye views, respectively, of an example map related generated worst-case scenario, according to one or more embodiments. Using information related to occluded area 801 obtained from maps and/or semantic inference, worst-case constraint generation causes vehicle 802 to cautiously approach intersection 800. In this example, occluded area 801 is occluded due to topography, which can either be known apriori or detected using perception system 402.

### Example Behaviors from Worst-Case Scenarios

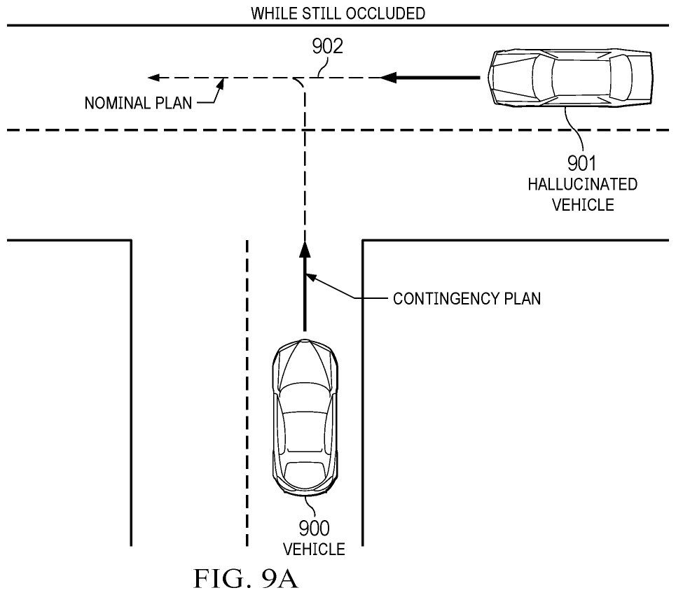

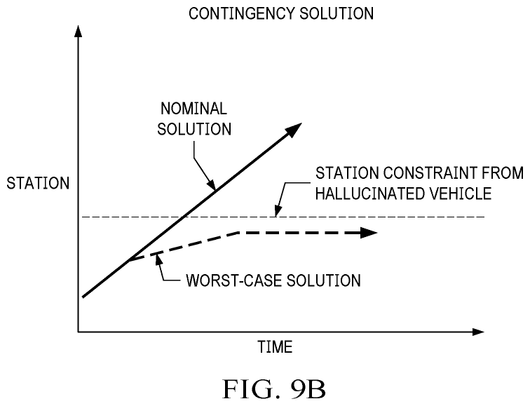

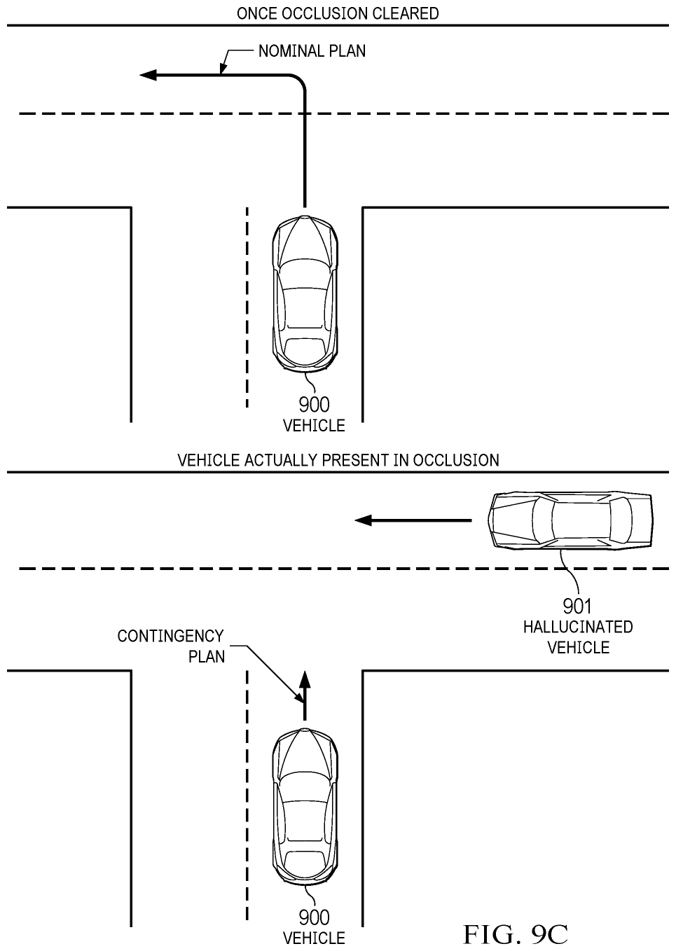

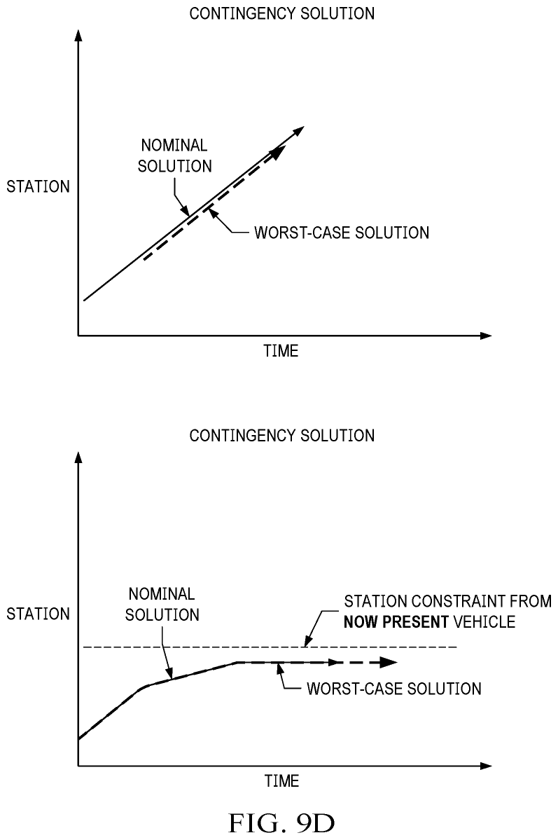

FIG. 9A illustrates behaviors from generated worst-case constraints, according to one or more embodiments. Information from occluded area 801 (see FIG. 8) is used to generate hallucinated vehicle 901. Reachable state predictor 606 (see FIG. 6) is used to find worst-case path 902 for hallucinated vehicle 901. In this example, the contingency solution is constrained to obey constraints imposed by the trajectory of hallucinated vehicle 901. By letting vehicle 900 consider the uncertainty of whether there is a vehicle in occluded area 801, vehicle 900 behaves cautiously. FIG. 9B is a station time graph showing the maneuver including the nominal solution, worst-case solution and the station constraint from hallucinated vehicle 901.

FIG. 9C illustrates that once the occlusion is cleared, vehicle 900 behaves normally and proceeds on its way. If there is actually a vehicle in occluded area 801, vehicle 900 can still brake in time to avoid collision. FIG. 9D shows a station time graph showing the maneuver including the nominal solution, worst-case solution and the station constraint from hallucinated vehicle 901, for the case when the occlusion has cleared.

### Example Semantics Related Worst-Case Scenarios

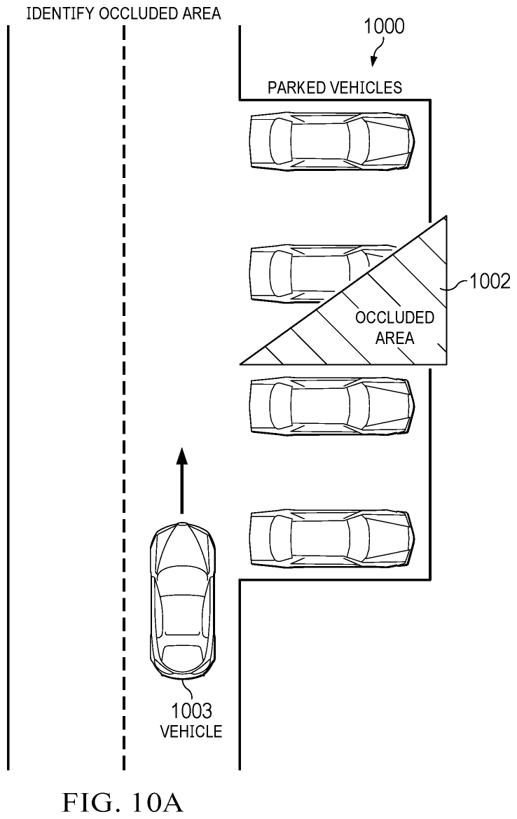

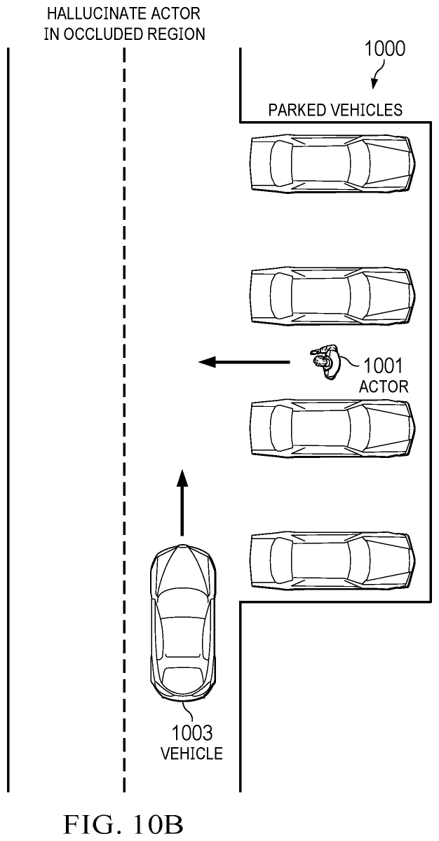

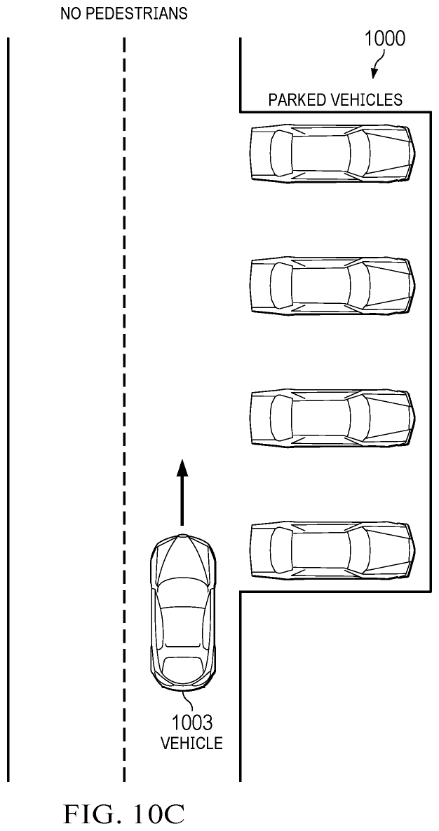

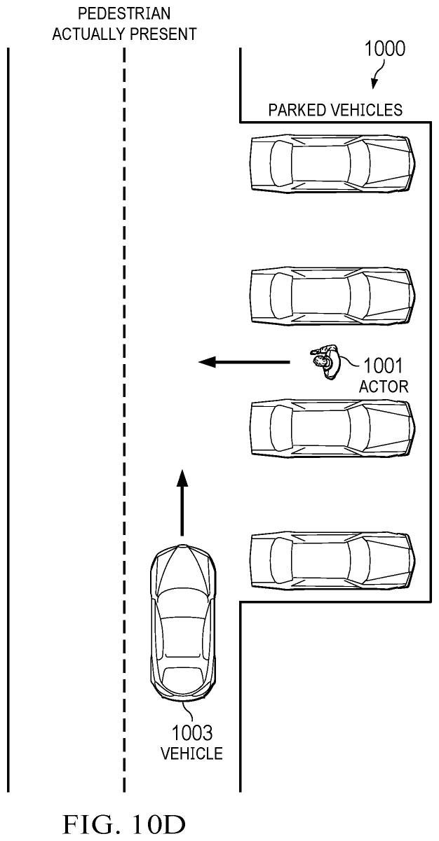

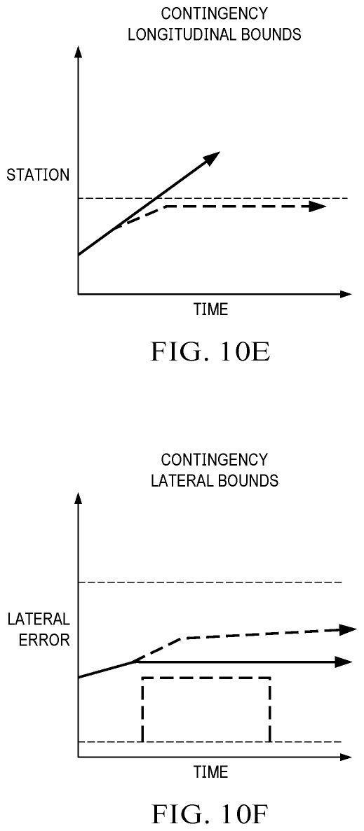

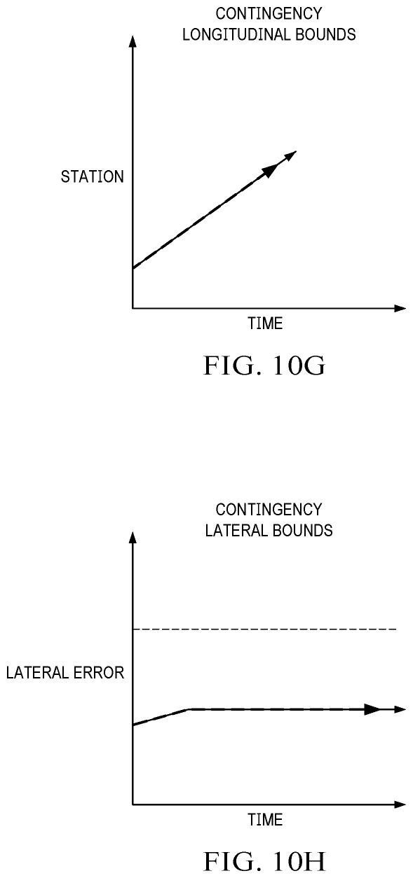

FIGS. 10A and 10B illustrate semantics related worst-case scenarios, according to one or more embodiments. Semantics related worst-case constraints may arise from information about the layout of a scene. In the example shown, worst-case scenario generation can leverage the semantic information about a row of parked vehicles 1000 to hallucinated actor 1001 (e.g., a pedestrian) in occluded area 1002 (shown in FIG. 10A) and construct a worst-case scenario. In this example worst-case scenario, set of lateral and longitudinal constraints are consumed that allow vehicle 1003 to cautiously bias and slow down for hallucinated actor 1001.

There may arise two cases when approaching a row of parked vehicles 1000 while occlusion is present. One in which pedestrian 1001 is not present as shown in FIG. 10C and one in which pedestrian 1001 is present as shown in FIG. 10D. In either case, vehicle 1003 shows cautious behavior in approaching the row of parked vehicles 1000. If pedestrian 1001 is present, vehicle 1003 will safely brake and bias to give pedestrian 1001 room. If pedestrian 1001 is not present, vehicle 1003 will continue on its way with minimal discomfort.

FIGS. 10E and 10F are a station-time graph showing contingency longitudinal bounds and a graph of lateral error versus time for contingency lateral bounds, respectively, when the occlusion is present.

FIGS. 10G and 10H are a station-time graph showing contingency longitudinal bounds and a graph of lateral error versus time for contingency lateral bounds, respectively, when the occlusion is no longer present.

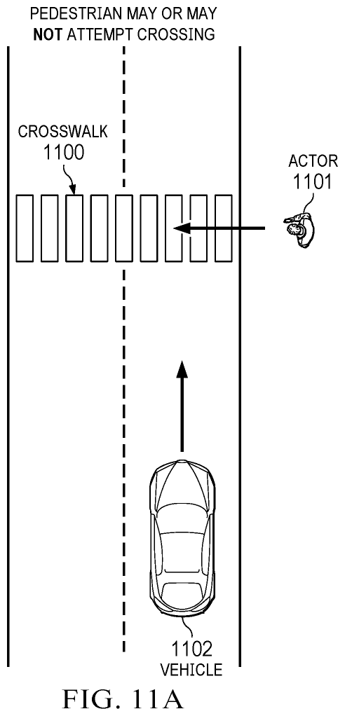

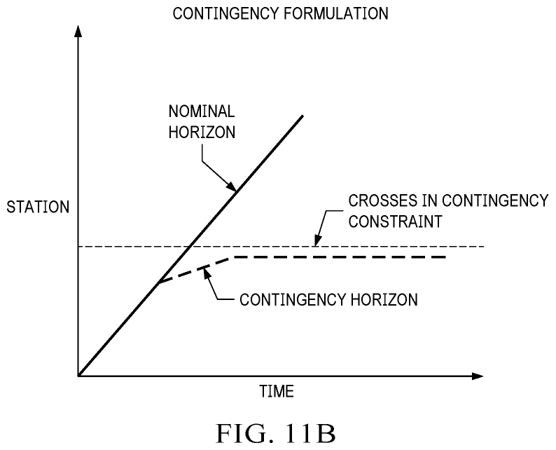

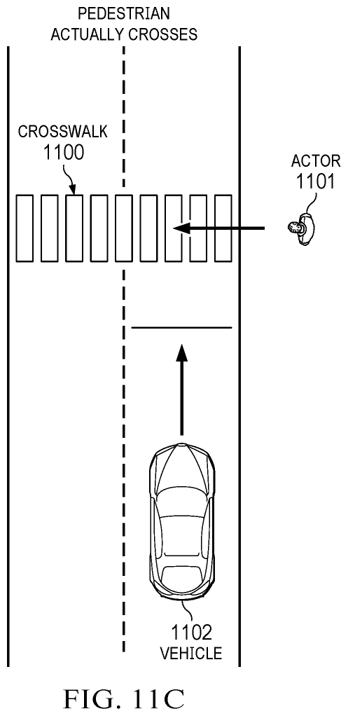

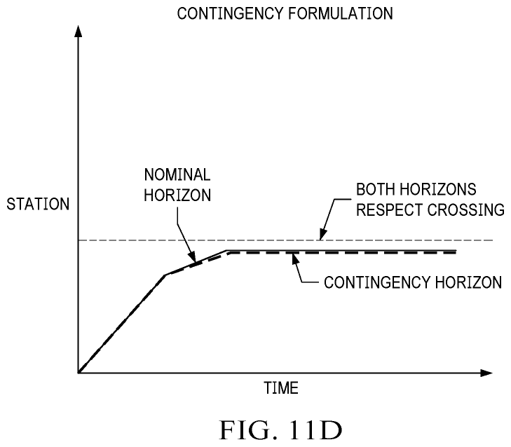

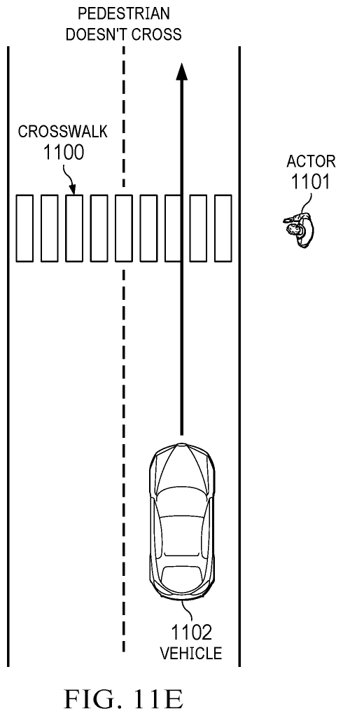

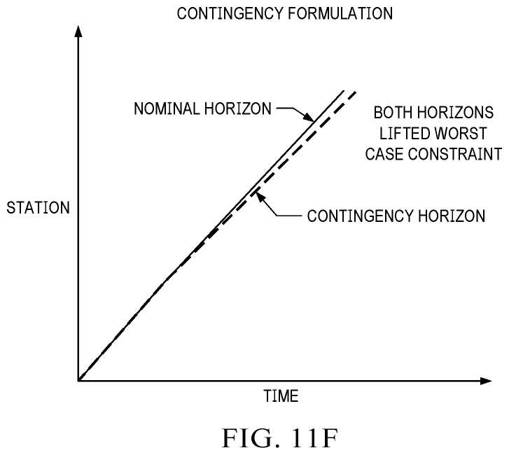

FIG. 11A illustrates an additional semantics related worst-case scenario, according to one or more embodiments. An additional semantics related worst-case scenario that can be generated is crosswalk behavior. A set of constraints can be generated that plans for both pedestrian 1101 crossing and not crossing (yielding to vehicle 1102) at crosswalk 1100. The worst-case analysis of pedestrian 1101 dictates his/her crossing velocity.

FIG. 11B shows a station-time graph showing the maneuver for the crosswalk worst-case scenario including the nominal solution, worst-case solution and the station constraint from pedestrian 1101.

FIG. 11C illustrates the case where pedestrian 1101 actually crosses crosswalk 1100, and FIG. 11D illustrates the corresponding station-time graph.

FIG. 11E illustrates the case where pedestrian 1101 does not cross crosswalk 1100, and FIG. 11F illustrates the corresponding station-time graph. As shown, vehicle 1102 exhibits cautious behavior that allows for safety if pedestrian 1101 does cross crosswalk 1100 and smooth minimally intervening behavior if pedestrian 1101 does not cross crosswalk 1100.

### Example Most-Constraining Assumed Worst-Case Scenarios

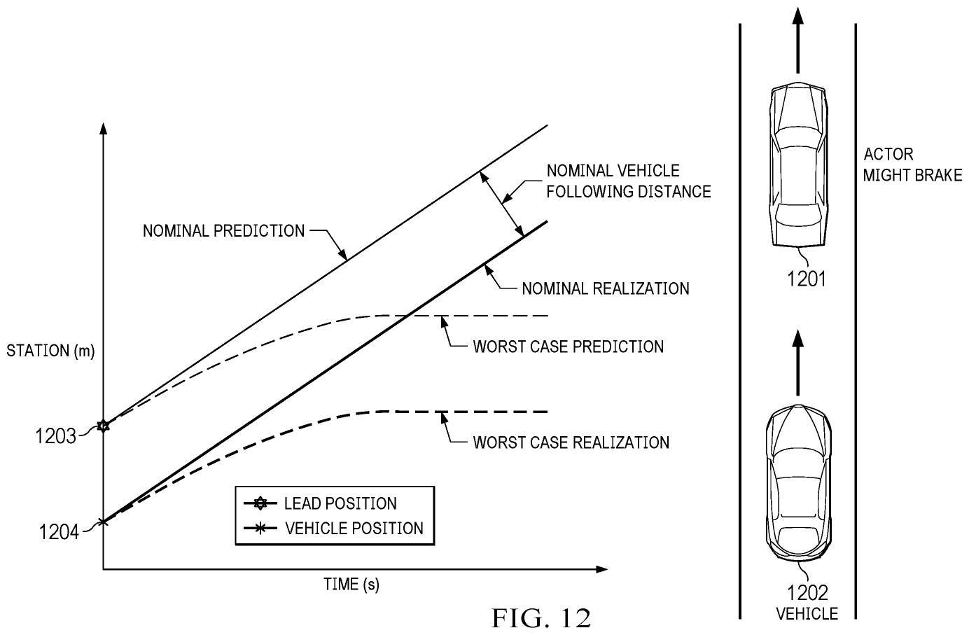

FIG. 12 is a station-time graph that illustrates most-constraining assumed worst-case scenarios, according to one or more embodiments. The graph shows nominal prediction, nominal realization, worst-case prediction, worst-case realization for nominal vehicle following distance are shown. Initial vehicle/actor vehicle position 1203 and vehicle position 1204 are shown as stars.

In the worst-case scenarios described above only the currently visible or hallucinated actors are considered for worst-case generation, where the most constraining actor in the nominal cases does not necessarily match the most constraining actor in the worst-case. The most-constraining actors are considered and their trajectories are generated with reachable state predictor 606 (see FIG. 6) to make the worst-cases predictions shown in FIG. 12 for the scenario where vehicle/actor 1201 is leading vehicle/ego 1202 and may brake, as described in reference to FIG. 7A.

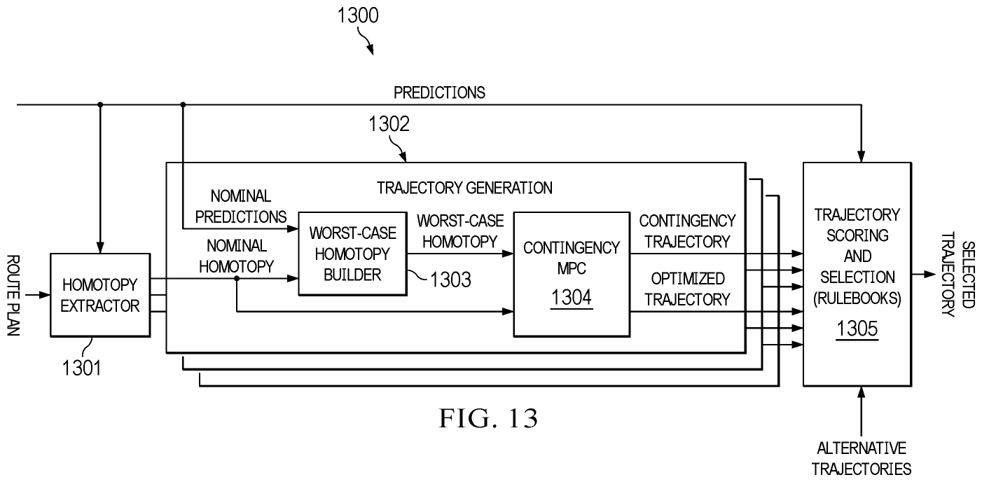

FIG. 13 is a block diagram of motion planner 1300 for an AV that uses nominal and contingency MPC, according to some embodiments. Motion planner 1300 includes homotopy extractor 1301 (e.g., homotopy extractor 600 shown in FIG. 6), trajectory generator 1302 and trajectory scoring and selection block 1305. Trajectory generator 1302 generates contingency and optimized trajectories from nominal and worst-case homotopies. Trajectory generator 1302 further includes worst-case homotopy builder 1303 and contingency MPC 1304.

For purposes of illustration, the following description of motion planner 1300 will be with respect to an implementation of motion planner 1300 by planner system 404. However, it will be understood that in some examples motion planner 1300 (e.g., one or more components of motion planner 1300) is implemented by other systems different from, or in addition to, planning system 404 such as perception system 402, localization system 406, and/or control system 408. While motion planner 1300 includes certain features as described herein, these features are provided for the purpose of illustration and are not intended to limit the present disclosure.

Referring to FIG. 13, object predictions from a perception system (e.g., perception system 402) and a route plan from a route planner (e.g., planner system 404) are input into homotopy extractor 1301, which extracts nominal homotopies for a particular scenario. The extracted worst-case homotopies and nominal homotopies are input into contingency MPC 1304, which generates contingency and optimized trajectories using, for example, Equations [1]-[5].

The contingency and optimized trajectories are then input together with the object predictions into trajectory scoring and selection block 1305, which applies rulebook(s) to the trajectories to determine a score for each trajectory based, for example, the number and degree of rule violations resulting from the trajectory.

In some embodiments, a “rulebook” is a data structure implementing a priority structure on a set of rules that are arranged based on their relative importance, where for any particular rule in the priority structure, the rule(s) having lower priority in the structure than the particular rule in the priority structure have lower importance than the particular rule. Possible priority structures include but are not limited to: hierarchical structures (e.g., total order or partial-order on the rules), non-hierarchical structures (e.g., a weighting system on the rules) or a hybrid priority structure in which subsets of rules are hierarchical but rules within each subset are non-hierarchical.

Rules can include traffic laws, safety rules, ethical rules, local culture rules, passenger comfort rules and any other rules that could be used to evaluate a trajectory of a vehicle provided by any source (e.g., humans, text, regulations, websites). The rulebook(s) specify the solution space for the trajectory optimization, defined by the motion plan provided by a planning module, such as, e.g., the planning module 404.

In an embodiment, a score can be assigned to each trajectory such that trajectories with less rule violations and/or less degree of rule violations receives a higher score. The highest scoring trajectory is the selected trajectory to be sent to trajectory tracker 504 (see FIG. 5). In other embodiments, a score can be assigned to each trajectory such that trajectories with more rule violations and/or more degree of rule violations receives a higher score, and the lowest scoring trajectory is the selected trajectory to be sent to trajectory tracker 504. In some embodiments, trajectory scoring and selection 1305 also receives alternative trajectories to be considered in trajectory and scoring.

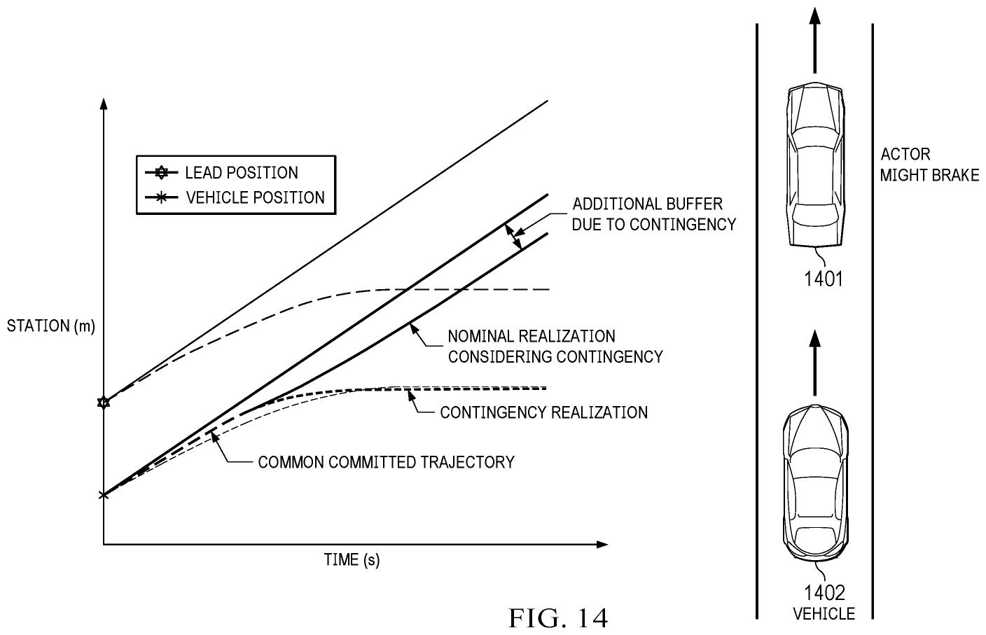

FIG. 14 is a station-time graph that illustrates the benefits of motion planner 1300 for the example of an agent 1401 in a lead position in front of vehicle 1402 and suddenly stopping. Motion planner 1300 computes trajectories that consider nominal and worst-case (contingency) homotopies. The nominal trajectory realizations and predictions are shown as solid lines and the worst-case trajectory realizations and predictions are shown as dashed lines. Also shown is the contingency trajectory realization As can be observed from this graph, the result of the worst-case constraints (contingency) being considered in the MPC optimization problem is an additional buffer for the nominal trajectory realization.

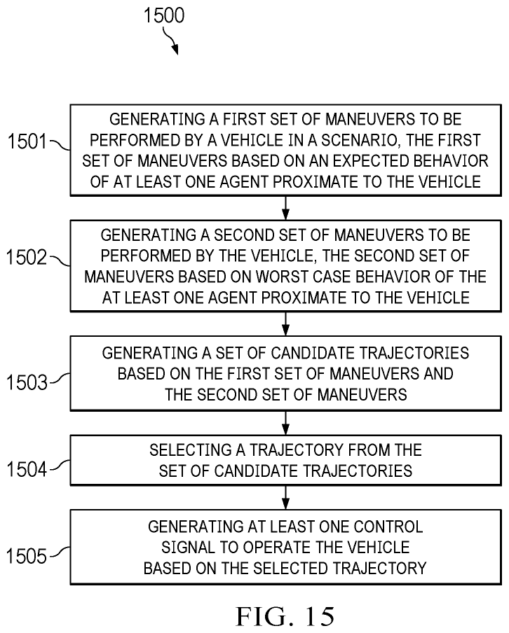

FIG. 15 is a flow diagram of a process 1500 for motion planning that considers worst-case scenarios for trajectory realization, according to one or more embodiments. For purposes of illustration, the following description of process 1500 will be with respect to an implementation of process 1500 by planner system 404. However, it will be understood that in some examples process 1500 is implemented by other systems different from, or in addition to, planning system 404 such as perception system 402, localization system 406, and/or control system 408. While process 1500 includes certain steps as described herein, these steps are provided for the purpose of illustration and are not intended to limit the present disclosure.

Process 1500 includes: generating a first set of maneuvers to be performed by a vehicle in a scenario, the first set of maneuvers based on an expected behavior of at least one agent proximate to the vehicle (1501); generating a second set of maneuvers to be performed by the vehicle, the second set of maneuvers based on worst case behavior of the at least one agent proximate to the vehicle (1502); generating a set of candidate trajectories based on the first set of maneuvers and the second set of maneuvers (1503); selecting a trajectory from the set of candidate trajectories (1504); and generating at least one control signal to operate the vehicle based on the selected trajectory (1505). Each of these steps were previously described in reference to FIGS. 5-14.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1. A method comprising:
generating, with at least one processor, a first set of maneuvers to be performed by a vehicle in a scenario, the first set of maneuvers based on an expected behavior of at least one agent proximate to the vehicle;
generating, with the at least one processor, a second set of maneuvers to be performed by the vehicle, the second set of maneuvers based on worst case behavior of the at least one agent proximate to the vehicle;
generating, with the at least one processor, a set of candidate trajectories based on the first set of maneuvers and the second set of maneuvers;
selecting, with the at least one processor, a trajectory from the set of candidate trajectories; and
generating, with the at least one processor, at least one control signal to operate the vehicle based on the selected trajectory.

2. The method of claim 1, further comprising:
adding, based on at least one of map information or perception information, at least one observed agent, or at least one hallucinated agent in an occluded part of a map of the operating environment of the vehicle; and
obtaining the second set of maneuvers from a set of predetermined worst-cases based on a specified scenario based on the at least one agent proximate to the vehicle and the at least one hallucinated agent.

3. The method of claim 2, wherein the predetermined worst-cases are associated with a location of the vehicle relative to the map.

4. The method of claim 2, wherein the predetermined worst-cases are semantics related to the at least one agent.

5. The method of claim 2, wherein obtaining the predetermined worst-cases comprises obtaining predetermined worst cases that are assumed worst-cases from specified agents.

6. The method of claim 5, further comprising: combining the second set of candidate maneuvers in a union to extract a most constrained second maneuver.

7. The method of claim 2, wherein generating the second set of candidate trajectories comprises:
generating the second set of candidate trajectories based on a reachable state prediction of how far and where the at least one hallucinated agent will travel in a specified amount of time.

8. The method of claim 7, further comprising generating the second set of candidate trajectories based on velocity or acceleration profiles of the at least one hallucinated agent.

9. The method of claim 7, further comprising generating the second set of candidate trajectories based on lane graph parameters.

10. The method of claim 2, wherein there are two or more hallucinated agents added to the occluded part of the map, and the method further comprises:
selecting at least one most constraining hallucinated agent; and
generating the second set of trajectories for the selected at least one most constraining hallucinated agent.

11. The method of claim 1, wherein generating at least one control signal comprises:
inputting constraint sets for the nominal and contingency maneuvers into a model-based predictive control (MPC); and
generating the at least one control signal based on a solution output by the MPC.

12. The method of claim 11, further comprising generating the at least one control signal based on an optimization of at least one cost function and the constraint sets.

13. A system comprising:
at least one processor;
memory storing instructions that when executed by the at least one processor, cause the at least one processor to perform operations comprising:
generating a first set of maneuvers to be performed by a vehicle in a scenario, the first set of maneuvers based on an expected behavior of at least one agent proximate to the vehicle;
generating a second set of maneuvers to be performed by the vehicle, the second set of maneuvers based on worst case behavior of the at least one agent proximate to the vehicle;
generating a set of candidate trajectories based on the first set of maneuvers and the second set of maneuvers;
selecting a trajectory from the set of candidate trajectories; and
generating at least one control signal to operate the vehicle based on the selected trajectory.

14. The system of claim 13, further comprising:
adding, based on at least one of map information or perception information, at least one observed agent, or at least one hallucinated agent in an occluded part of a map of the operating environment of the vehicle; and
obtaining the second set of maneuvers from a set of predetermined worst-cases based on a specified scenario based on the at least one agent proximate to the vehicle and the at least one hallucinated agent.

15. The system of claim 14, wherein the predetermined worst-cases are associated with a location of the vehicle relative to the map.

16. The system of claim 14, wherein the predetermined worst-cases are semantics related to the at least one agent.

17. The system of claim 14, wherein obtaining the predetermined worst-cases comprises obtaining predetermined worst cases that are assumed worst-cases from specified agents.

18. The system of claim 17, further comprising: combining the second set of candidate maneuvers in a union to extract a most constrained second maneuver.

19. The system of claim 14, wherein generating the second set of candidate trajectories comprises:
generating the second set of candidate trajectories based on a reachable state prediction of how far and where the at least one hallucinated agent will travel in a specified amount of time.

20. The system of claim 19, further comprising generating the second set of candidate trajectories based on velocity or acceleration profiles of the at least one hallucinated agent.

21. The system of claim 19, further comprising generating the second set of candidate trajectories based on lane graph parameters.

22. The system of claim 14, wherein there are two or more hallucinated agents added to the occluded part of the map, and the method further comprises:
selecting at least one most constraining hallucinated agent; and
generating the second set of trajectories for the selected at least one most constraining hallucinated agent.

23. The system of claim 13, wherein generating at least one control signal comprises:
inputting constraint sets for the nominal and contingency maneuvers into a model-based predictive control (MPC); and
generating the at least one control signal based on a solution output by the MPC.

24. The system of claim 23, further comprising generating the at least one control signal based on an optimization of at least one cost function and the constraint sets.
